(19) United States
(12) Patent Application Publication
(10) Pub. No.: US 2008/0059909 A1
(43) Pub. Date: Mar. 6, 2008

(54) ENHANCED LIST BASED USER INTERFACE IN MOBILE CONTEXT

(76) Inventors: Rita Parada, Vancouver (CA); David Leong, Richmond (CA); Rob Barret, Surrey (CA); Tom Deelman, Austin, TX (US); Jennifer Pretti, North Vancouver (CA); Scott Davis, North Vancouver (CA); Selma Zafar, Vancouver (CA); Joanna Zander, North Vancouver (CA); Kirsi Kelloniemi, Tampere (FI); Petter Karlsson, Vancouver (CA)

Correspondence Address: PERMAN & GREEN, 425 POST ROAD, FAIRFIELD, CT, 06824, US

(21) Appl. No.: 11/469,590

(22) Filed: Sep. 1, 2006

(51) Int. Cl. G06F 3/048

(52) U.S. Cl. 715/841; 715/853

(57) ABSTRACT

A mobile communication apparatus including a display and means for navigating among items displayed on the display, arranged to display a first list of items belonging to a higher hierarchical level on the display and being capable of enabling selection of a first item among the higher hierarchical level items by the means for navigation is disclosed. Upon selection of the first item, being arranged to insert and display a second list including at least one item belonging to a lower hierarchical level between the first item and subsequent higher hierarchical level items for enabling selection of a second item from the second list, wherein the second list is hierarchically associated with the first item. A corresponding application, apparatus and computer program are also disclosed.

### TECHNICAL FIELD

The disclosed embodiments relate to methods for displaying and selecting items in a portable apparatus, a rendering application, a portable apparatus comprising a display and means for navigating, and a computer-readable medium having computer-executable components.

### BACKGROUND

Many times, items are stored in a device with processing and storage capabilities, such as a computer, a media player, and nowadays also mobile communication apparatuses, arranged in a hierarchical tree structure. The items in the tree structure are assigned a hierarchical level, and each item, except items on the top or ‘root’ level, is associated with another item on a higher level. As the number of items increases, and/or the complexity of the tree structure increases, it becomes more cumbersome for a user to manage browsing the items and to keep track of its position in the hierarchical tree structure. This is especially problematic in an apparatus with a small physical size, since the display of the device accordingly provides less displaying area. U.S. Pat. No. 6,928,433 B2, which is hereby incorporated by reference, discloses a solution for organizing and selecting tracks for a playlist in a portable music player. However, it is believed that improvements can be made that facilitates for a user to select among a plurality of items.

### SUMMARY

In view of the above, it would be advantageous to solve or at least reduce the problems discussed above. In particular, the disclosed embodiments provide a user friendly and display space efficient selection and browsing of items in a portable apparatus.

According to a first aspect, there is provided a method for a portable apparatus, comprising:

displaying a first list of items belonging to a higher hierarchical level in a display view;

enabling selection of a first item among said higher hierarchical level items; and

upon selection of said first item, inserting in said display view, a second list comprising at least one item belonging to a lower hierarchical level between said first item and subsequent higher hierarchical level items for enabling selection of a second item from said second list, wherein said second list is hierarchically associated with said first item.

The method may comprise indenting said inserted second list compared to said first list.

The method may comprise rendering a media item associated with said second item upon selection of said second item.

The method may comprise inserting a third list in said display view upon selection of said second item, the third list comprising at least one item belonging to a further lower hierarchical level between said second item and subsequent items for enabling selection of a third item from said third list, wherein said third list is hierarchically associated with said second item.

The method may comprise indenting said inserted third list compared to said first second.

The method may comprise rendering a media item associated with said third item upon selection of said third item.

The method may comprise scrolling items such that said first item is displayed uppermost of the displayed items.

The method may comprise providing symbols as visual cues to differentiate between said lists.

The method may comprise providing symbols as visual cues to indicate active level in the hierarchical structure.

The method may comprise providing arrows as visual cues to indicate the existence of selectable sub levels containing hierarchical connected items.

The method wherein said items may be items of the group comprising:

a phone book item, a media library item, and a ToDo list item.

The method may further comprise selection from any list in the hierarchical structure in said display view until a desired item for rendering is selected.

According to a second aspect there is provided a rendering application for a portable apparatus comprising a display and navigation means, said application causing a first list of items belonging to a higher hierarchical level to be displayed in a display view and being capable of enabling selection of a first item among said higher hierarchical level items by said means for navigation, wherein, upon selection of said first item, being arranged to cause insertion in said display view of a second list comprising at least one item belonging to a lower hierarchical level between said first item and subsequent higher hierarchical level items for enabling selection of a second item from said second list, wherein said second list is hierarchically associated with said first item.

According to a third aspect there is provided a portable apparatus comprising a display and a navigation device for navigation among items displayed on said display, arranged to display a view comprising a first list of items belonging to a higher hierarchical level on said display and being capable of enabling selection of a first item among said higher hierarchical level items by said means for navigation, wherein upon selection of said first item, being arranged to insert into said view a second list on said display comprising at least one item belonging to a lower hierarchical level between said first item and subsequent higher hierarchical level items for enabling selection of a second item from said second list, wherein said second list is hierarchically associated with said first item.

According to a fourth aspect there is provided a computer-readable medium having computer-executable components comprising instructions for displaying a first list of items in a display view belonging to a higher hierarchical level in a display view;

enabling selection of a first item among said higher hierarchical level items; and

upon selection of said first item, inserting in said display view, a second list comprising at least one item belonging to a lower hierarchical level, between said first item and subsequent higher hierarchical level items for enabling selection of a second item from said second list, wherein said second list is hierarchically associated with said first item.

The second, third and fourth aspects may be combined in any way with the optional features of the first aspect.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of said element, device, component, means, step, etc., unless explicitly stated otherwise. The steps of any method disclosed herein do not have to be performed in the exact order disclosed, unless explicitly stated.

Other features and advantages of the embodiments will appear from the following detailed disclosure, from the attached dependent claims as well as from the drawings.

### BRIEF DESCRIPTION OF THE DRAWINGS

The above, as well as additional features and advantages of the disclosed embodiments will be better understood through the following illustrative and non-limiting detailed description of preferred embodiments, with reference to the appended drawings, where the same reference numerals will be used for similar elements, wherein:

FIG. 1 shows a mobile communication apparatus according to an embodiment;

FIG. 2,a-c, shows exemplary display views according to an embodiment;

FIG. 3 illustrates a hierarchical structure used in one embodiment;

FIG. 4 is a flow chart illustrating a method according to an embodiment;

FIG. 5 shows a display view;

FIG. 6 shows a display view;

FIG. 7 shows a display view;

FIG. 8 shows a display view;

FIG. 9 shows a display view;

FIG. 10 shows a display view; and

FIG. 11a-c, shows item selection procedures.

### DETAILED DESCRIPTION OF PREFERRED EMBODIMENTS

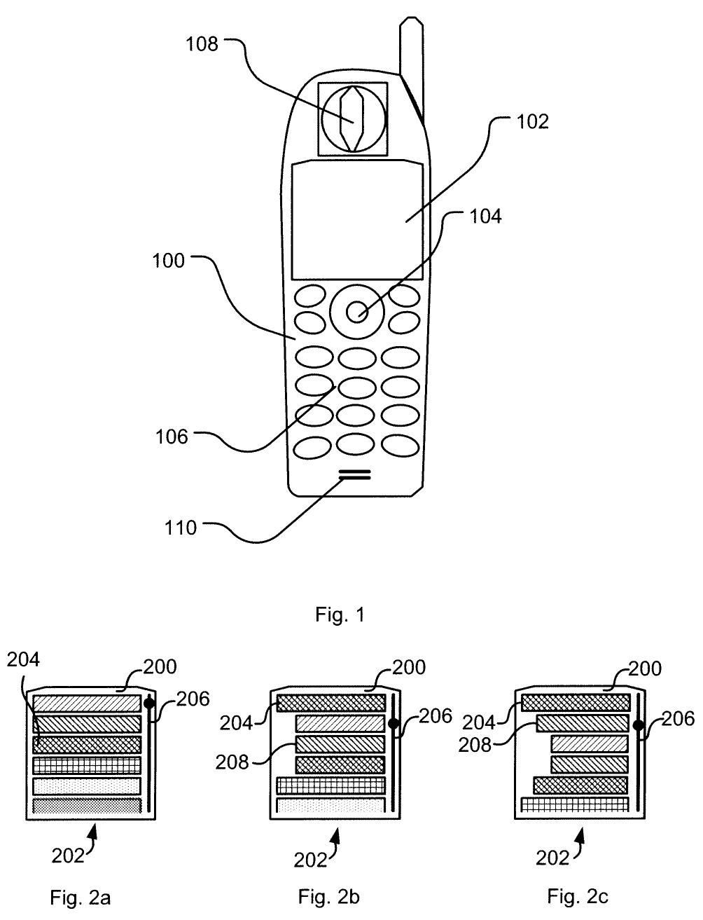

FIG. 1 shows a mobile communication apparatus 100 comprising a display 102 and means 104 for navigating among items (not shown) displayed in a display area 102. The navigation means 104 can be a rotating input, a joystick, a touch pad, but can also be implemented using a touch sensitive display, wherein the displayed items directly can be tapped by a user for selection, or be voice activated via a headset or a built-in microphone. The mobile communication apparatus can also comprise other elements normally present in such an apparatus, such as a keypad 106, a speaker 108, a microphone 110, a processor (not shown), a memory (not shown), etc.

FIG. 2 shows the displaying of items 202 on a display 200 in the form of a list, wherein FIG. 2a shows the display 200 displaying a number of items, indicated by the patterned bars, in a first list. Assume that the third uppermost item 204 is selected. The selected item 204 will preferably be displayed on the top of the display view and the entire items list is thus scrolled, indicated by the scroll bar 206, in such way that the selected item 204 ends up on the top of the display view, as shown in FIG. 2b. Further, upon selection of the item 204, a second list of items is inserted between the selected item 204 and the successive items of the first list in the display view, illustrated in FIG. 2b, wherein the items of the second list are hierarchically associated with the selected item 204. The hierarchically associations with item 204 can further be emphasized by e.g. indenting the second list of items as shown in FIG. 2b. A user is thus also enabled to select items also from the second list. If the selected item 204 is re-selected in the state shown in FIG. 2b, the second list is preferably concealed, and the view according to FIG. 2a is once again displayed. If another item from the first list is selected in the state shown in FIG. 2b, another indented list of items is inserted between the another selected item and the successive items of the first list, wherein the items of the another indented list are hierarchically associated with the other selected item. If an item 208 from the second list is selected, either information associated with the item 208 is renderable, e.g. playing a media clip, or a third indented list of items is inserted between the selected item 208 and the following items, as is illustrated in FIG. 2c, wherein the items of the third list are hierarchically associated with the selected item 208. Depending on the number of levels in the hierarchy the item selection and list insertion can continue in the same manner until the lowest level in the hierarchy is reached.

For facilitating navigation of long item lists, a scroll bar 206 can be displayed on the display 200.

The items in FIG. 2 have been assigned patterns instead of real information text to make the disclosure more clear and not to obstruct the principle by text examples only giving understanding to few familiar with knowledge of relations between the items of an example. Similarities between patterns in items in different hierarchical levels are not an illustration of relationship. Thus, same pattern in same hierarchical level illustrates that it is the same item, and items placed below another item but with a slight indent illustrates hierarchical relationship with the item above.

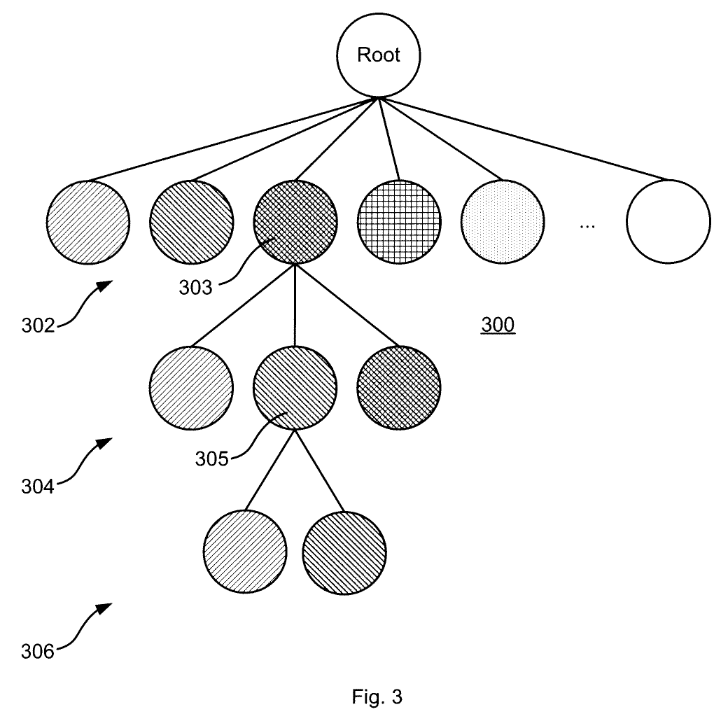

To illustrate the hierarchy in the example in FIG. 2, FIG. 3 shows a part of the hierarchical structure 300 in the example, wherein the structure can be considered to have an imaginary ‘root’ under which all of the top items 302 belonging to the highest level of the structure. Among these top items 302, we take a closer look at item 303, which is hierarchically associated to items 304 at the one step lower level in the hierarchy. Among these items 304, we take a closer look at item 305, which is hierarchically associated to items 306 at the further one step lower level in the hierarchy. As readily can be seen, the above discussed items 302-306 correspond to the items displayed in the example of FIG. 2.

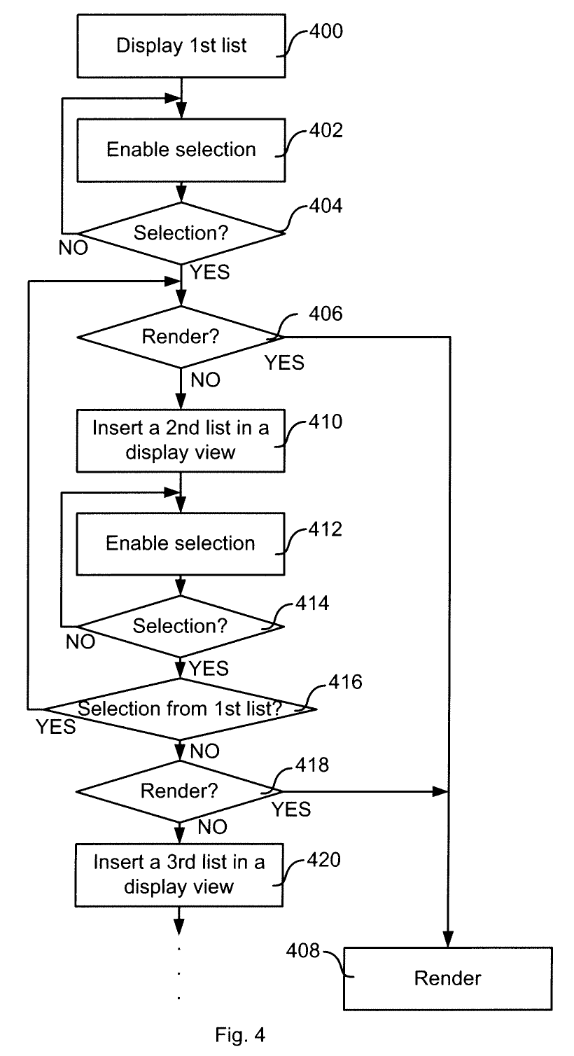

FIG. 4 is a flow chart illustrating a method according to one embodiment. It is readily understood that the complexity of the method will increase as the number of levels in a corresponding hierarchical structure increases. Thus, the method illustrated by FIG. 4 should be regarded as exemplary, and similar methods related to more or less complex hierarchical structures are readily understood when reading the description below with reference to FIG. 4.

In a displaying step 400, a first list of items belonging to a higher hierarchical level is displayed. Thus, in a selection enablement step 402, a user is enabled to make a selection of a first item among the higher hierarchical level items, wherein it is checked 404 whether any selection is made. Thus, selection enablement step 402 is processed until there has been a selection. It can also be checked 406 if selection indicates that information associated with the selected item should be rendered directly. If that is the case, a rendering step 408 will be processed. Otherwise, a second list of items is inserted and displayed between the first item and subsequent items of the higher hierarchical level in the display view in displaying step 410, wherein the second list comprises items hierarchically associated with the selected first item. Thus, in a second selection enablement step 412, a user is enabled to make a selection of a second item among the displayed items, wherein it is checked 414 whether any selection is made. Thus, the selection enablement step 412 is processed until there has been a selection.

Optionally, there can be checked 416 if the selection is made of an item from the first list, wherein a list of items hierarchically associated with the selected item is inserted and displayed between the selected item and subsequent items of the higher hierarchical level, or, if the selected item is the first item, concealing the second list and thus returning to displaying step 400.

It can also be checked 418 if selection indicates that information associated with the selected item should be rendered directly. If that is the case, a rendering step 408 will be processed. Otherwise, a third list of items is inserted and displayed between the selected item and subsequent items in the displaying view in displaying step 420.

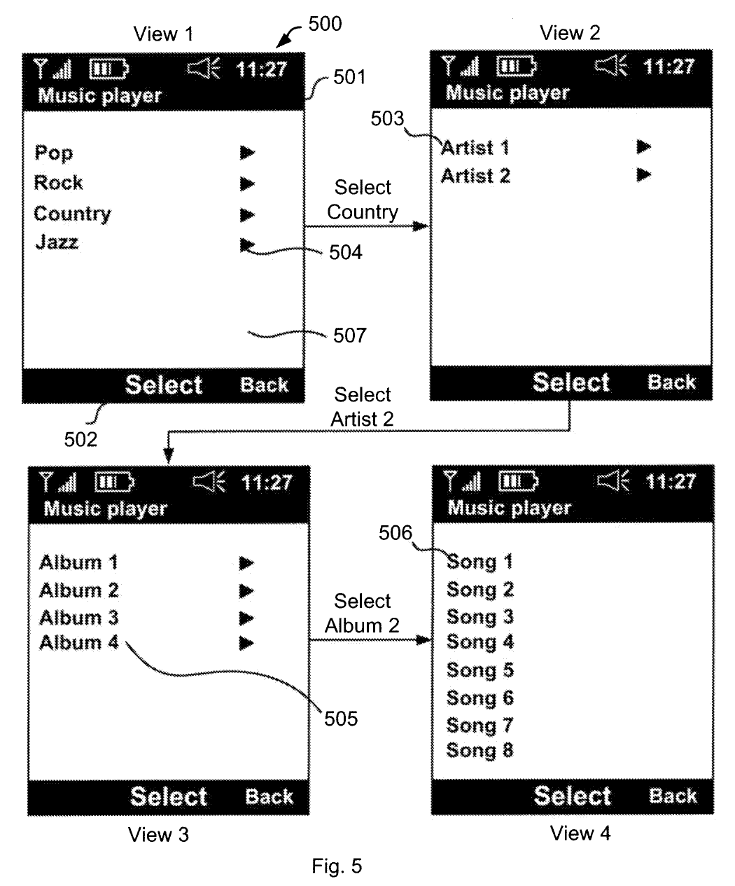

FIG. 5 illustrates an example of a common display view in a mobile communication apparatus 500 comprising a general status indication section 501, a softkey bar 502 and a general display area 507. The general status indication section 501 can for example include symbols for battery status, reception quality, speaker on/off present mode, clock time, etc. The status indication section is not in any way limited to only include these symbols. Thus, other symbols in any shape, form or colour can occur. The softkey bar 502, situated at the bottom of the display view, is operable using the navigation means 104 mentioned in conjunction with FIG. 1. The function of these softkeys are not limited by the functions indicated in the figure.

The preferred function of the general display area 507, residing between the status indication section 501 at the top and the softkey bar 502 at the bottom, is to display information from running applications in the mobile communication apparatus. In our case the display area 507 displays lists of items which are manoeuvrable with the aid of the navigation means 104 in FIG. 1.

Throughout this disclosure, references have been made to a hierarchical structure. The hierarchical structure can be fixed by a specification or application, or dynamically assigned, as will be discussed below.

The navigation and the dynamics of the hierarchy structure will be explained by an series of examples, all in a context of a music library. However, as will be readily understood by a skilled person, the principle applies in a similar way to other contexts, such as phone books, photo albums, web link collections, To Do lists, etc.

A music track can have a set of meta data associated. The meta data can comprise name of artist, song title, album title, composer, producer, genre, etc.

In our example in FIG. 5, the display area further comprises a hierarchical item lists of meta data categories 503 with associated arrows 504 indicating further selectable sub levels of the hierarchically associated items. The user of the mobile communication apparatus can be prompted to select one of the meta data categories define as the highest level in the hierarchy. For example, the meta data category ‘Genre’ have been selected to be the top level. In view 1 a list of sub level items can then be displayed, such as ‘Pop’, ‘Rock’, ‘Country’, and ‘Jazz’. If a user then selects one of the items from the list, for example ‘Country’, a new display view appears, view 2, displaying a new sub level with, in this case, an item list of country artists 503. A further selection by the user, for example ‘Artist 2’, will in its turn display a new display view, view 3, where a new hierarchical item list of albums, from that particular artist, which are hierarchical associated with the selected artist item is displayed. If the user for example selects the item ‘Album 2’ a new display view, view 4, showing a list of items of songs hierarchically related to the selected album list item appears. The songs, which in this particular example is on the lowest level in the hierarchy, can be rendered.

Note that in most mobile communication apparatuses, such as in the example above, the hierarchy association between meta data categories are predefined and not user configurable.

When the amount of items in the meta data categories, such as artists, albums and songs, increases rapidly, as they tend to do in nowadays mobile communication apparatuses with large storage space, the navigation among the hierarchical ordered items becomes cumbersome to navigate and it is easy to lose ones bearings of where in the hierarchical structure one are.

One way of reducing the navigation difficulties and mitigating the feeling of being lost when navigating large amounts of hierarchical structured items, in a in a mobile communication apparatus, or other apparatus with a limited display area such as a PDA, portable media player, etc., is presented in the following examples of embodiments of the present invention.

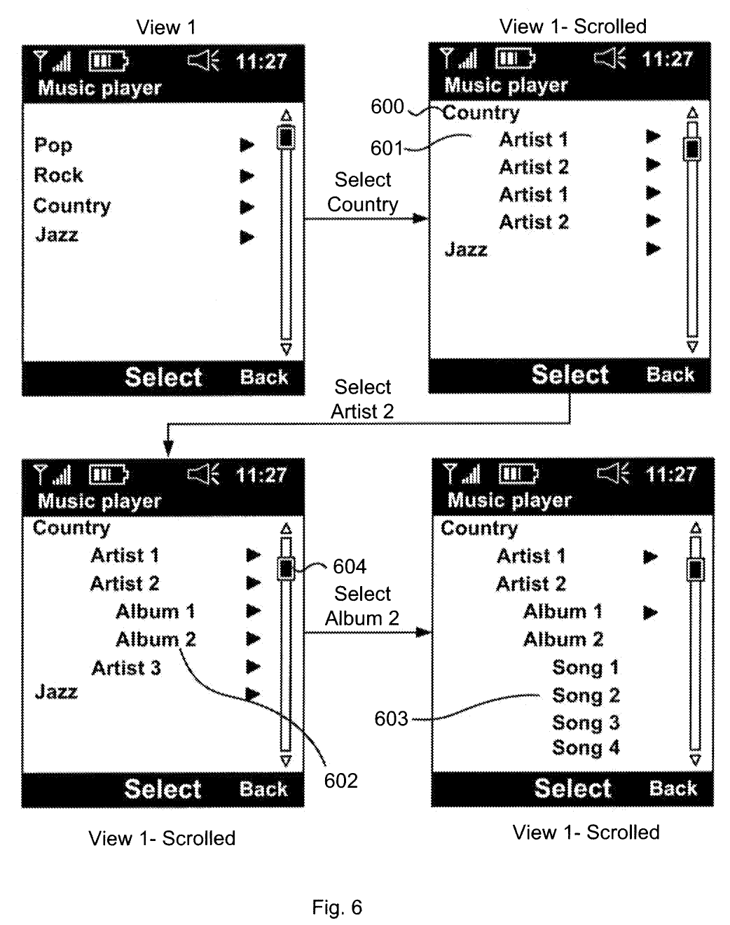

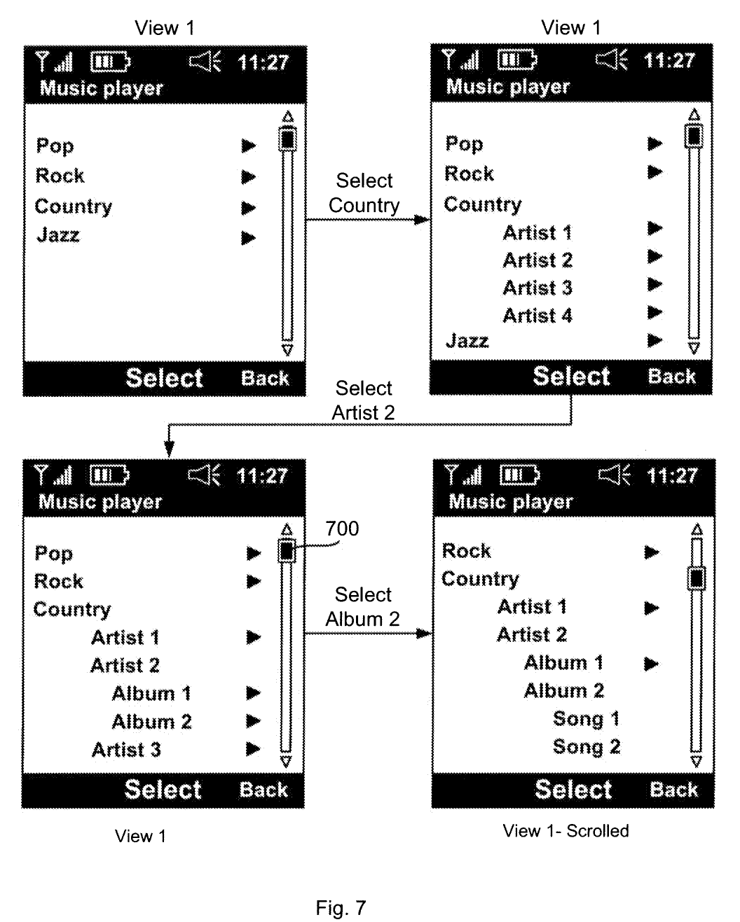

FIG. 6 shows an embodiment where the common display area is the same as in the example in FIG. 5, and the same hierarchically associated item lists with meta data are used as in the example in FIG. 5. A user can be prompted to selects one of several meta data categories, such as ‘Pop’, ‘Country’, ‘Rock’ and ‘Jazz’, to define the top or root level in the hierarchy. If a user selects the meta data item ‘Country’ 600, in view 1, from the top hierarchical items list, the whole items list with will be scrolled, within view 1, so that item ‘Country’ 601 is positioned at the top of the display area and an indented items list of artists 601 is inserted between the items ‘Country’ and ‘Jazz’. The scrolling of items indicated by a scroll bar 604 placed at the right hand side of the display area 604. If a user chooses to select item ‘Artist 2’ from said indented list of items, a new indented list of album items are inserted between said ‘Artist 2’ and ‘Artist 3’ 602. If item ‘Album 2’ is selected a new indented items list comprising song items 603 hierarchically related to the ‘Album 2’ items are inserted in the same manner, in said view 1. The displaying of the hierarchical associated items ‘Country’, ‘Artist 2’, ‘Album 2’ and ‘Song’, are all displayed as an indented tree structure in the same view of the display area, not in separate views as in the example in FIG. 5. The complete hierarchical tree structure is scrollable in the same view as indicated by the scroll bar 604. An example of scrolling the entire tree structure is shown in FIG. 7.

The tree structure makes navigating among the items very user friendly and it clearly shows how items are related to each other and where in the structure one are, which mitigates the effect of feeling lost in the tree structure. Note that this example comprises a plurality of levels, but the user can choose to have fewer, as well as more, levels for the dynamically selected hierarchy, depending on the desires of the user. In the example discussed above, a user has been able to set up the dynamically assigned hierarchy tree structure, but it is readily understood that this set-up can be made by an administrator of the media library, or which type of items to be structured, a service provider, or an operator.

FIG. 7 shows the same example of a hierarchically tree structure with indented list items of meta data as in FIG. 6, but more clearly showing how the scrollbar 700 can be utilized to scroll through the hierarchical structure and easily select items on different hierarchical levels without backing through a series of display views corresponding to the different levels in the hierarchy.

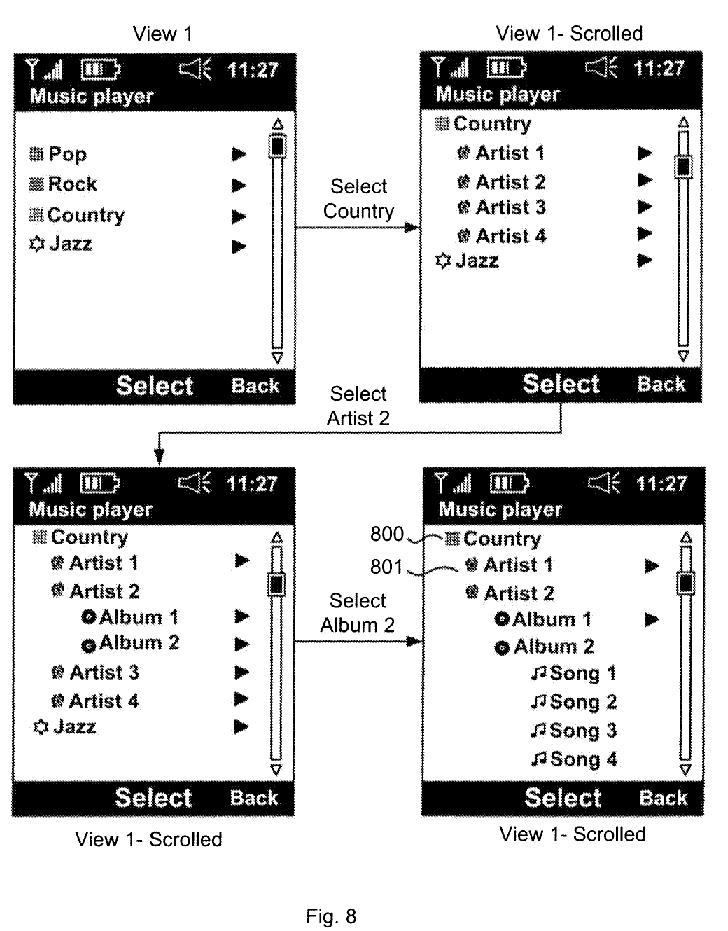

One way of enhancing the indenting the tree structure, and to give the user more visual cues of where in the hierarchical tree structure one resides, is to add a visual cue, such as an symbol, in front of similar items on the same level in the hierarchical structure. FIG. 8 shows one embodiment with added visual cues to similar items in the tree structure. In the example in FIG. 8 the visual cues are made up of different symbols. The ‘Country’ item on the top level in the tree structure is marked by a square checkered symbol 800 and the ‘Artist 1’ item is marked with a “crowd of people” symbol 801. However, visual cues are not limited to the symbols presented in the example in FIG. 8, or even symbols for that matter. They could consist of any type of differentiating symbols, objects or marking such as animated objects, different font styles, different colorations of the fonts or different backgrounds of items belonging to the same level, etc. This enhancement to the indented tree structure is especially efficient to use in handheld devices with a larger display area such smart phones, PDAs, etc.

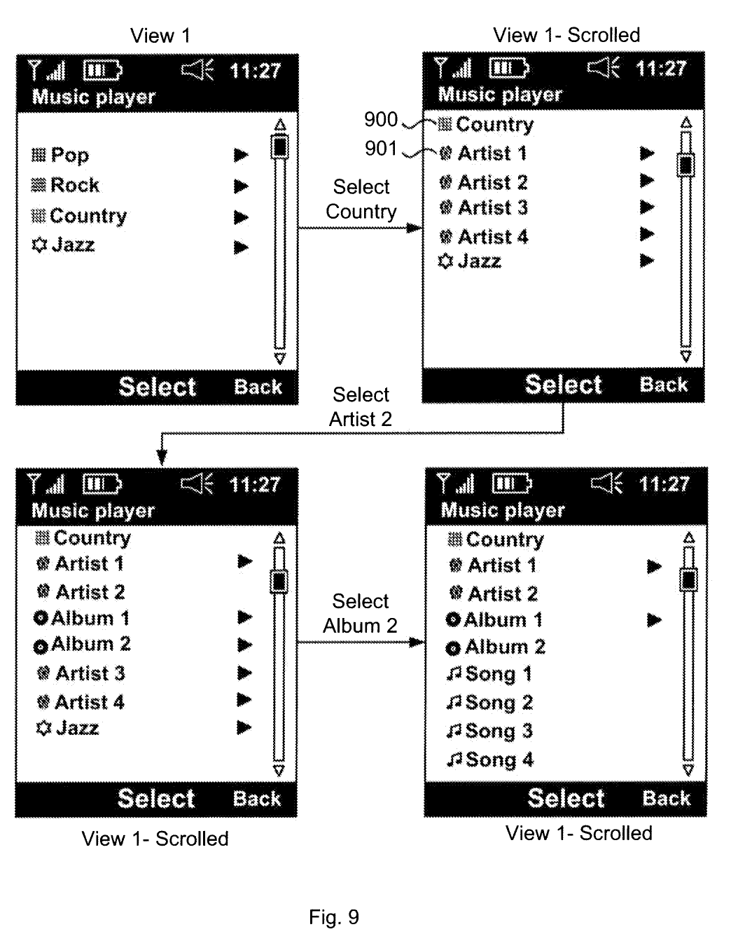

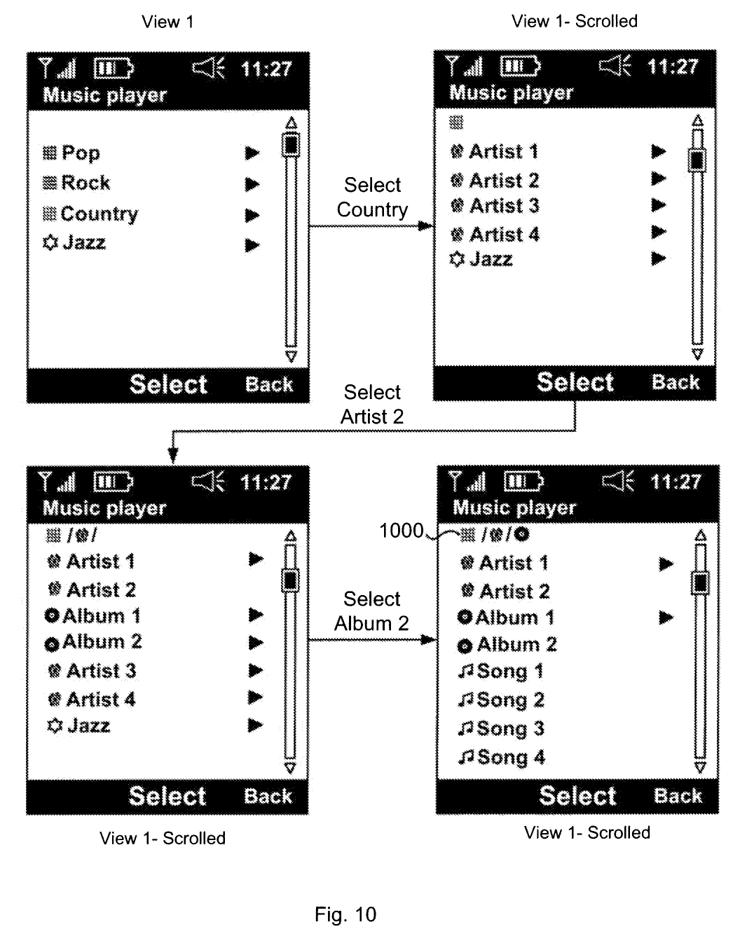

If the display area of the mobile communication apparatus is extremely precious, such as in a small sized cell phone, an alternative way of communicating the hierarchical level information is by using visual cues only and removing the indenting and thereby compacting the display space needed for the hierarchical structure. One example of this is shown in FIG. 9 where the visual cues are represented by symbols instead of indents, as in the example in FIG. 8. Each item list belonging to a specific hierarchical level share the same symbol. For example the ‘Country’ item is indicated by a square checkered symbol 900 in front of the item name, the item ‘Artist 1’ has a ‘crowd of people’ symbol 901 and so on. The symbol will in this case serve as a visual cue, and group similar items and indicate which level in the hierarchical tree structure the item or the group of items belongs to.

A way of enhancing the compacted hierarchical structure presented in FIG. 9 is to place a visual cue on the top of the display area which tells the user on which level in the hierarchical structure one are. One way is to place symbols 1000, corresponding to the symbol representing a specific hierarchical level in the structure, separated by slashes to indicate on which level one are. FIG. 10 shows such an example where symbols are placed at the top of the display area 1000. In the example the symbols 1000 in the last display view communicate that the user have previous chosen the ‘Country’ level, ‘Artist’ level, ‘Album’ level and are currently in the ‘Song’ level. As in the case of the examples in FIG. 8 and FIG. 9 the visual cue does not have to be in the form of symbols only.

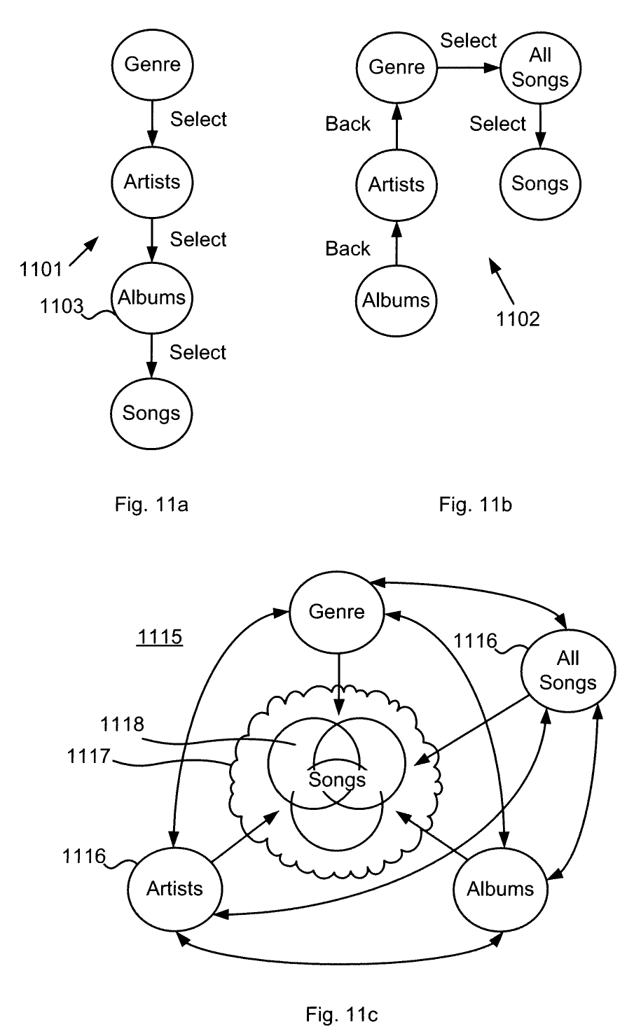

FIG. 11a illustrates an item selection procedure 1101 of a common mobile communication apparatuses as shown in FIG. 5 where each state, such as the album state 1103, represents a level with a selectable list of items in the overall hierarchical structure. If a user selects, as exemplified in FIG. 5, the item ‘Country’ belonging to the genre stat, a new display view is generated with the artist items belonging to the hierarchical sub level ‘Artists’. The user selection process can, as shown in FIG. 5, proceed throughout the hierarchical structure down to the sub level containing song items. FIG. 11b show an example of an user suddenly wanting to choose a ‘Song’ item from the ‘All Songs’ items view instead of from the ‘Albums’ view, on the ‘Album’ level. The user must then back up throughout the hierarchy by executing a series of ‘back’ commands until the user reaches the top level in the hierarchical tree structure. When the user have reached the top level ‘Genre’, the user is then able to select the another top level, for example ‘All Songs’ and move down throughout a new chain of states, with sub level items, by using a series of ‘select’ commands. This way of navigating throughout the hierarchical tree structure is quite cumbersome and not optimal.

FIG. 6 shows a new way of displaying and navigating the hierarchical tree structure is presented. Instead of having long item selection chains as in FIG. 11a and FIG. 11b, where it is cumbersome to navigate between and change between selection chains, the navigation of the display view in FIG. 6 can be illustrated as shown in FIG. 11c. Inserting an new items list in between to items, as shown in FIG. 6, is equivalent to moving between the different states shown in FIG. 11c. When the item ‘Country’ is selected from the ‘Genre’ items list, corresponding to the ‘Genre’ state in FIG. 11c, a new items list with ‘Albums’ is inserted in the same display view between the items of the higher level which corresponds to moving to the ‘Albums’ state in FIG. 11c. As shown in FIG. 6 it is still possible, in the same view, to select a another item from the ‘Genre’ items list without using a ‘back’ command. Moving in the hierarchical tree structure in the display view in FIG. 6 corresponds to moving between the states 1116 illustrates in FIG. 11c, and thereby effectively eliminating cumbersome navigation using back and select commands on the mobile communication apparatus. All selections of items in the states can in this example lead to a items list containing all ‘Song’ items 1117 or a subset of all ‘Song’ items 1118, depending on from which state such as ‘Albums’, ‘Artist’, etc. the ‘Song’ item is selected from, as illustrated by the intersecting rings 1118 in FIG. 11c.

1. A method for a portable apparatus, comprising:
displaying a first list of items belonging to a higher hierarchical level in a display view;
enabling selection of a first item among said higher hierarchical level items; and
upon selection of said first item, inserting in said display view, a second list comprising at least one item belonging to a lower hierarchical level between said first item and subsequent higher hierarchical level items for enabling selection of a second item from said second list, wherein said second list is hierarchically associated with said first item.

2. The method according to claim 1, further comprising indenting said inserted second list compared to said first list.

3. The method according to claim 1, further comprising rendering a media item associated with said second item upon selection of said second item.

4. The method according to claim 1, further comprising inserting a third list in said display view, upon selection of said second item, the third list comprising at least one item belonging to a further lower hierarchical level between said second item and subsequent items for enabling selection of a third item from said third list, wherein said third list is hierarchically associated with said second item.

5. The method according to claim 4, further comprising indenting said inserted third list compared to said first second.

6. The method according to claim 4, further comprising rendering a media item associated with said third item upon selection of said third item.

7. The method according to claim 1, further comprising scrolling items such that said first item is displayed uppermost of the displayed items.

8. The method according to claim 1, further comprising providing symbols as visual cues to differentiate between said lists.

9. The method according to claim 1, further comprising providing symbols as visual cues to indicate active level in the hierarchical structure.

10. The method according to claim 1, further comprising providing arrows as visual cues to indicate the existence of selectable sub levels containing hierarchical connected items.

11. The method according to claim 1, wherein said items are items of the group comprising:
a phone book item, a media library item, and a ToDo list item.

12. The method according to claim 1, further comprising selection from any list in the hierarchical structure in said display view until a desired item for rendering is selected.

13. A rendering application for an portable apparatus comprising a display and navigation means, said application causing a first list of items belonging to a higher hierarchical level to be displayed in a display view and being capable of enabling selection of a first item among said higher hierarchical level items by said means for navigation, wherein, upon selection of said first item, being arranged to cause insertion in said display view of a second list comprising at least one item belonging to a lower hierarchical level between said first item and subsequent higher hierarchical level items for enabling selection of a second item from said second list, wherein said second list is hierarchically associated with said first item.

14. The application according to claim 13, further comprising means for rendering media, wherein a media item associated with said second item is enabled to be rendered upon selection of said second item.

15. The application according to claim 13, being arranged to insert a third list in said display view, upon selection of said second item, the third list comprising at least one item belonging to a further lower hierarchical level, between said second item and subsequent items for enabling selection of a third item from said third list, wherein said third list is hierarchically associated with said second item.

16. The application according to claim 13, being arranged to, upon displaying the first list and the second list of items, enable selection of a third item from said first list, wherein upon selection of said third item, the application being arranged to conceal said second list on the display.

17. The application according to claim 13, further being arranged to indent said inserted second list compared to said first list.

18. The application according to claim 15, being arranged to insert a third list, in said display view, comprising at least one item belonging to a lower hierarchical level between said third item and subsequent higher hierarchical level items for enabling selection of a fourth item from said third list, wherein said third list is hierarchically associated with said third item.

19. The application according to claim 13, further being arranged to scroll items such that said first item is displayed uppermost of the displayed items on the display.

20. The application according to claim 15, further arranged to indent said inserted third list compared to said first second.

21. The application according to claim 13, further arranged to provide symbols as visual cues to differentiate between said lists.

22. The application according to claim 13, further arranged to provide symbols as visual cues to indicate active level in the hierarchical structure.

23. The application according to claim 13, further arranged to provide arrows as visual cues to indicate the existence of selectable sub levels containing hierarchical connected items.

24. A portable apparatus comprising a display and a navigation device for navigation among items displayed on said display, arranged to display a view comprising a first list of items belonging to a higher hierarchical level on said display and being capable of enabling selection of a first item among said higher hierarchical level items by said means for navigation, wherein upon selection of said first item, being arranged to insert into said view a second list on said display comprising at least one item belonging to a lower hierarchical level between said first item and subsequent higher hierarchical level items for enabling selection of a second item from said second list, wherein said second list is hierarchically associated with said first item.

25. The apparatus according to claim 24, further comprising a media renderer, wherein a media item associated with said second item is enabled to be rendered upon selection of said second item.

26. The apparatus according to claim 24, being arranged to insert a third list into said view, upon selection of said second item, the third list comprising at least one item belonging to a further lower hierarchical level, between said second item and subsequent items for enabling selection of a third item from said third list, wherein said third list is hierarchically associated with said second item.

27. The apparatus according to claim 24, being arranged to, upon displaying the first list and the second list of items, enable selection of a third item from said first list, wherein upon selection of said third item, the apparatus being arranged to conceal said second list on the display.

28. The apparatus according to claim 27, being arranged to insert a third list comprising at least one item belonging to a lower hierarchical level, between said third item and subsequent higher hierarchical level items for enabling selection of a fourth item from said third list, wherein said third list is hierarchically associated with said third item.

29. The apparatus according to claim 24, further being arranged to scroll items such that said first item is displayed uppermost of the displayed items on the display.

30. The apparatus according to claim 24, further comprising a phone book, wherein said items are items in the phone book.

31. The apparatus according to claim 24, further comprising a media library, wherein said items are items in the media library.

32. The apparatus according to claim 24, further comprising a ToDo list, wherein said items are items in the ToDo list.

33. The apparatus according to claim 24 belonging to a group comprising: PDA, mobile communication apparatus, portable media player.

34. A computer-readable medium having computer-executable components comprising instructions for displaying a first list of items in a display view belonging to a higher hierarchical level in a display view; enabling selection of a first item among said higher hierarchical level items; and
upon selection of said first item, inserting in said display view, a second list comprising at least one item belonging to a lower hierarchical level, between said first item and subsequent higher hierarchical level items for enabling selection of a second item from said second list, wherein said second list is hierarchically associated with said first item.

35. The computer-readable medium according to claim 34, further comprising instructions for rendering a media item associated with said second item upon selection of said second item.

36. The computer-readable medium according to claim 34, comprising instructions for indenting said inserted second list compared to said first list.
